(19) United States
(12) Patent Application Publication
(10) Pub. No.: US 2001/0014945 A1
(43) Pub. Date: Aug. 16, 2001

(54) Protection of security critical data in networks

(76) Inventor: Hans-Joachim Muschenborn, Bonn (DE)

Correspondence Address: Warren B. Kice, Haynes and Boone, LLP, Suite 3100, 901 Main Street, Dallas, TX, 75202-3789, US

(21) Appl. No.: 09/740,925

(22) Filed: Dec. 19, 2000

(30) Foreign Application Priority Data
Dec. 20, 1999 (DE) 199 61 399.0

(51) Int. Cl. H04L 12/22; H04L 9/00

(52) U.S. Cl. 713/201; 713/162; 709/227

(57) ABSTRACT

Existing network systems based upon the client/server principle require on the server side the provision of open connection endpoints. The large number of server processes implies a large number of open connection endpoints. Each open connection endpoint is also a potential target for an ill-minded attacker. The present invention minimizes the risk of a break-in into a network with security critical data.

This problem is solved by minimizing the number of open connection endpoints, the temporary opening of selected connection endpoints and the random choice of the local identifications of the opened connection endpoints. Additionally, security critical data is isolated onto machines, which after build-up of predefined standing connections do not provide any open connection endpoints or establish further connections. This prohibits the build-up of uncontrolled connections to units storing security critical data and still offers the controlled access of the security critical data within the network. Security critical services are able to provide different protocols for different connections and allow the remote administration of the security critical data without granting normal clients access to administrative protocols or functions. Individual protocols or individual functions of individual protocols can be activated, deactivated, dynamically loaded or released into or out of the addressable memory of a security critical service during normal operation.

### TECHNICAL FIELD

This invention concerns the protection of security critical data in networks according to one of claims 1 to 34.

### BACKGROUND OF THE INVENTION

In modern networks frequently the problem exists that specific data—like authorization data or client accounts—is on one hand required for the operation of the network and on the other hand highly security critical. Such data should only be accessible and/or manipulated by defined users. The problem exists equally for purely private networks, like company own intranets, as well as and especially for public networks, like the Internet. In addition, many companies are currently present in the Internet and have to fear break-ins from public networks due to weak protections of their internal networks. The potential economical losses originating form hacked data can even cause bankruptcy of a compromised company. The cause of many successful attacks is the fact that modern networks systems are build according to the classical client/server-model and the often large number of server-processes with many open connection endpoints (sockets) running on many server units. The risk of a successful break-in increases with increasing number of open connection endpoints, since every open connection endpoint may also serve as target for an ill-minded client.

The security hazard can only be reduced by a radical reduction of the number of open connection endpoints and server-processes, which contradicts the client/server architecture. A solution of this problem is presented in this patent.

Prior art logical connections are established according to the client/server principle in the following way:

A physical unit identified by a unique physical id executes a thread (called server), which provides at least one logical connection endpoint identified by a local id unique on the server executing unit and waits until another thread (called client) running on the same or another unit tries to connect to said endpoint. Supposed the units executing the server and the client are physically connected via a network, the client needs at least the physical id of the server executing unit and the locally unique id of the connection endpoint which the server provides. Both ids together are enough to uniquely identify the connection endpoint of the server in the network. After reception the server decides to accept or deny a connection request. A connection is only established, if the server accepts the connection request, eventually after a positive result of an additional client authentication. In case of a negative client authentication the server terminates the connection build-up and no connection is established. According to this scheme only point-to-point connections between a single server and a single client can be established. Logical connections between two clients, two servers or more than two clients and/or servers are not possible.

A connection between a client and a server can only exist for a single transaction (temporary connection) or last for longer time intervals (standing connections). After termination of all transactions one of the communication partners closes the connection whereupon the other partner closes the connection endpoint on his side.

A typical example of such networks is the Internet or Internet like intranets, which are build of several programmable and physically linked computers, each executing an operating system, the network and the application programs. Homogenous systems contain identical or different computers controlled by the same operating system. Heterogeneous systems contain similar or different computers controlled by the same or different operating systems. The networking programs typically follow the ISO/OSI-model, use the UDP/IP- or TCP/IP-stacks and serve for the information exchange between different software components running on the same or different machines.

The mentioned description of prior art client/server systems in general is explained in the following paragraph taking the TCP/IP-protocol as well known example. The TCP/IP-protocol is per definition a connection oriented protocol based on the ISO/OSI-model between two uniquely identified communication partners, which permits on the one hand to build up a logical point-to-point connection between one unique client and one unique server, and on the other hand guarantees the reliable physical and logical message transmission between server and client, such that the transmitted bytes are received in the same order as they were sent, independent of the number of physical data packets a message needed to be split during physical transport and independent of the physical path each individual data packet was transmitted over the physical network.

A connection endpoint of a TCP/IP-server process is uniquely identified by the IP-address of the machine executing the TCP/IP-server process and its port-address. The port-address can be interpreted as a logical address, locally unique on the machine executing the server process. Thus, network wide unique TCP/IP-server addresses comprise the physical IP-address as well as the port address. The vector (IP-address, port-address) is bound to the TCP/IP-server machine and not logical (i.e. not independent of the physical unit), because it contains the IP-address of the TCP/IP-server machine.

Typical systems working according to the described client/server principle are the operating systems Unix, Windows NT, OS/2 or Netware as well as the middleware DCE, TUXEDO or CORBA.

Prior art networks have the following security problems:

1. Each open connection endpoint of a server running on a unit connected to the network is a potential target for an ill-minded attacker. If a unit provides multiple open connection endpoints of one or more servers, each individual connection endpoint is a potential target.

2. The security of the complete system is given by the security of the weakest server and decreases with increasing number of servers.

3. Prior art Internet-like networks provide their system functionality via server processes. In practice, individual units execute a huge number of servers with an equally huge number of open connection endpoints.

4. A well defined coherent security standard for a complete system can only be guaranteed, if each individual server is implemented according to the same security standard.

In practice a system wide coherent security standard can be achieved only at extremely high costs, since

1. each individual server has to implement the required security mechanisms,

2. the security mechanisms of each individual server have to be tested and verified,

3. during opera-ion the access to each individual server has to be continuously monitored, and

4. during operation each client transaction with a server has to be monitored and authorized.

If one or more servers are provided by independent software companies, additional problems arise especially with respect to nondisclosure of the (internal) security standards, the availability of the server source code (for modifications and/or verification) and/or the liability in case of losses.

### OBJECT OF THIS INVENTION

The object of this invention is to provide security critical data in networks such that an unauthorized access is technically impossible.

### SUMMARY OF THIS INVENTION

Existing network systems based upon the client/server principle require on the server side the provision of open connection endpoints. The large number of server processes implies a large number of open connection endpoints. Each open connection endpoint is also a potential target for an ill-minded attacker. The present invention minimizes the risk of a break-in into a network with security critical data.

This problem is solved by minimizing the number of open connection endpoints, the temporary opening of selected connection endpoints and the random choice of the local identifications of the opened connection endpoints. Additionally, security critical data is isolated onto machines, which after build-up of predefined standing connections do not provide any open connection endpoints or establish further connections. This prohibits the build-up of uncontrolled connections to units storing security critical data and still offers the controlled access of the security critical data within the network. Security critical services are able to provide different protocols for different connections and allow the remote administration of the security critical data without granting normal clients access to administrative protocols or functions. Individual protocols or individual functions of individual protocols can be activated, deactivated, dynamically loaded or released into or out of the addressable memory of a security critical service during normal operation.

### BRIEF DESCRIPTION OF THE FIGURES

Further objects, features and advantages of the present invention will become apparent from the following detailed description taken in conjunction with the accompanying figure showing a preferred embodiment of the invention, in which:

FIG. 1: illustrates a network system according to claim 1 with one central unit ZE running central process Z, a unit SE storing security critical data SD and running security critical service S and multiple peripheral processes P12, P21 & P22 on peripheral units PE11, PE21 & PE22.

FIG. 2a: illustrates a network system according to claim 3. In addition to the system shown in FIG. 1 the network is divided into two independent segments N1 and N2 where no messages are routed between N1 and N2. The central unit ZE is connected via two independent network interfaces IP1 and IP2 Lo both segments. Peripheral processes P11, P21 & P22 cannot directly access unit SE or service S, but are still able to access security critical data SD under control of Z and S.

FIG. 2b: illustrates a network system according to claim 5 divided into two independent segments N1 and N2. No messages are routed between N1 and N2. The central unit ZE is connected via two independent network interfaces IP1 and IP2 to both segments. During connection build-up to Z peripheral process P21 is authenticated by authorization service AS and authentication data AD. If AS authorizes P21, Z accepts the connection request of P21 and P21 is able to access the security critical data SD under control of Z and S.

FIG. 3a: Illustrates a network system according to claim 6 with a closed operational subsystem Z, indirect logon via LZ, local authentication by LZ and triggered temporary opening of the closed operational system Z.

FIG. 3b: illustrates the sequence of messages during connection build-up in the network system shown in FIG. 3a.

FIG. 4a: illustrates a network system according to claim 9 with a closed operational subsystem Z, indirect logon via LZ, remote authentication by AS and triggered temporary opening of the closed operational system Z.

FIG. 4b: in addition to FIG. 4a the logon subsystem LZ and the operational subsystem Z are running independently on separate units. The physical address of Z is either known by P21 in advance or transmitted during connection build-up via the logon subsystem.

FIG. 4c: illustrates the sequence of messages during connection build-up in the network system shown in FIGS. 4a and 4b.

FIG. 5a: illustrates a network system according to claim 22 wherein service S maintains two independent connections to subsystems Z and AZ. On the connection to AZ S provides protocol AP and on the connection to Z protocol PP.

FIG. 5b: illustrates the sequence of messages during connection build-up and for an authorized administrative transaction initiated by A in the network system shown in FIG. 5a.

### DETAILED DESCRIPTION OF THIS INVENTION

Prior art ne works reach the object of this invention by physically separated networks, which are protected with firewalls or proxy-server against each other. Traditional firewalls only check the connection build-up between client and server running in physically separated networks and do not offer the possibility to monitor and authorize individual transactions on the logical level. Proxy servers offer this possibility but execute after a positive authorization check as clients temporary transactions to secondary (protected) servers. Both solutions have the disadvantage that security critical data is stored on units executing at least one server process which always has to provide at least one open connection endpoint.

The present patent solves the stated problem by a network system according to claim 1, such that units storing security critical information—called security critical units—do not execute any server processes and

1. the security critical service—implemented as client—establishes at least one standing connection to one central process—implemented as server—, or

2. the security critical service—implemented as server—accepts only redefined standing logical connections from at least one central process—implemented as client—and after the establishment of this(ese) connection(s) does not provide any open connection endpoints, such that no further connections to the security critical service can be established.

Since no additional connections can be established to the security critical unit a direct access of the security critical unit bypassing the network system is technically impossible. The security critical information can be accessed in the network only via the predefined connections, at least one central process and at least one security critical service.

In a network system according to claim 2 at least one peripheral process is able to communicate indirectly via the central process with at least one service out of a group of services identified with a unique identification.

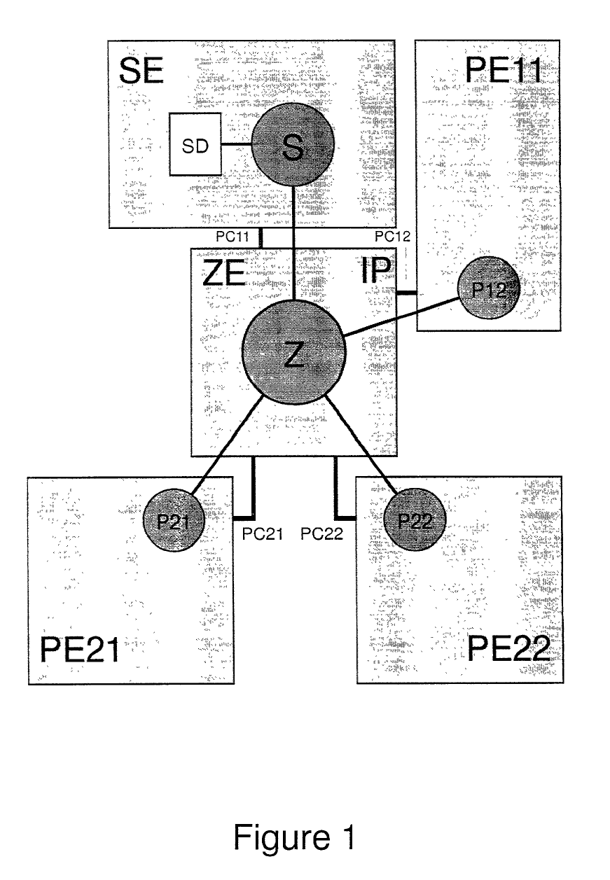

FIG. 1 illustrates an incarnation of a network system according to claims 1 or 2 consisting of a central unit ZE connected via a network interface with address IP and the physical connections PC11, pC12, PC21 and PC22 with units SE, PE11, PE21 and PE22.

Unit ZE executes a central process Z accepting connections from processes running on SE, PE11, PE21 and PE22. Unit SE stores security critical data SD which should be accessible from authorized network components. SE executes for this purpose a security critical process S maintaining a standing logical connection to process Z on ZE. Once this connection has been established S does not provide any open connection endpoints, does not accept further connection requests and does no establish further connections. Except S no other threads are running on SE, which establish, accept or maintain logical connections. The standing connection between S and Z is the only logical connection to SE such that security critical data SD can only be accessed via this connection controlled by S and Z.

Each peripheral process P12, P21&P22 establishes a standing logical connection to Z and has the possibility to communicate via Z with S. Z only forwards authorized requests from a peripheral process to S and authorized replies from S to a peripheral process. S determines the functionality of the access of the security critical data SD.

A network according claim 3 is additionally divided into two physical segments, where messages between the two segments are not routed, where the unit storing the security critical data—called security critical unit—as part of one segment cannot be reached by units of the other segment—called uncritical segment—, and where a central process controls the traffic between the security critical and the uncritical segment(s). This solution offers threefold protection of the security critical data:

1. an attack of the security critical data bypassing the central process and the security critical service is technically impossible, because the communication to the security critical unit is only possible via the pre-established connections and no thread on the security critical unit provides an open connection endpoint for an ill-minded attacker,

2. the direct access of the security critical unit is further impossible for all threads running in uncritical segments, since messages between the security critical segment and the uncritical segments are not routed, and

3. messages within the security critical segment cannot be “sniffed” by ill-minded attacker(s) in uncritical segments, because they are not transmitted through any uncritical segments.

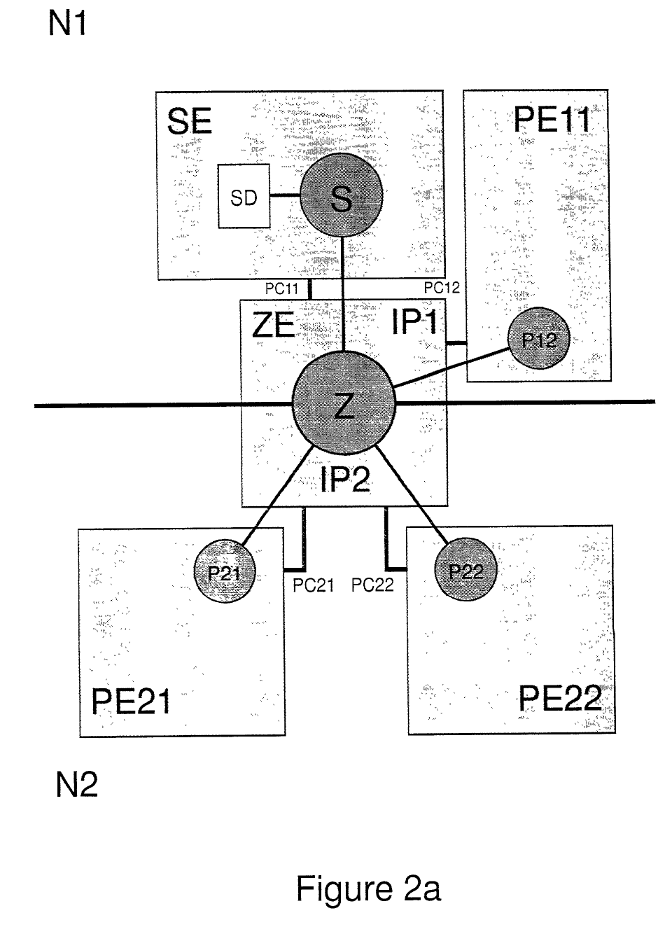

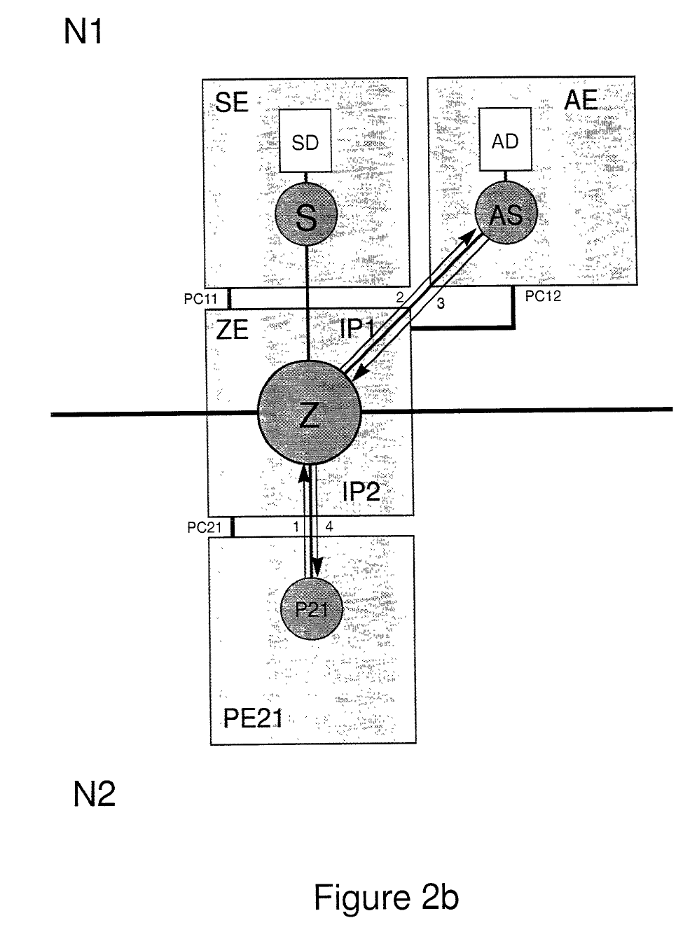

FIG. 2a illustrates an incarnation of a network according to claim 3 comprising two separated network segments N1 (security critical) and N2 (uncritical). No units of segment N1 can establish direct connections to units of segment N2, because no messages are routed between N1 and N2. Unit ZE is connected to segment N1 via a network interface with address IP1 and to segment N2 via another network interface with address IP2.

Units SE&PE11 in N1 are connected via the physical connection PC11/12 with network interface IP1 of unit ZE. Units PE21&PE22 in N2 are connected via the physical connection PC21/22 with network interface IP2 of unit ZE.

Unit ZE executes process Z which can accept connection requests via IP1 and IP2 from processes running in N1 or N2. Unit SE stores security critical data SD, which should be provided to authorized clients within the complete network (i.e. N1 & N2). For this purpose SE executes process S—called security critical service—maintaining a standing logical connection via physical connection PC11 and network interface IP1 to process Z on ZE. On top of this connection S does neither provide open connection endpoints, nor accepts incoming connection requests nor establishes other logical connections. Unit SE executes no other processes or threads except S, which establish or maintain logical connections or accept incoming connection requests. The connection between S and Z is the only logical connection to SE, forcing any access of data SD to be performed via this connection (under the control of S and Z).

Peripheral processes P12, P21 and P22 establish via physical connections PC12, PC21 and PC22 and network interfaces IP1 and IP2 standing logical connections to Z and have the possibility to communicate via Z with S. Z determines which messages from P12, P21 or P22 are authorized to be forwarded to S and which messages of S are authorized to be forwarded to P12, P21 or P22. S determines the functionality and kind of access of the protected data SD.

In network systems according to claims 4 and 5 a peripheral thread has to transmit additional authentication data, like its identity and password, after a successful connection to Z has been established, such that either the central process itself (claim 4) or an independent authorization service (claim 5) can check the access rights of the peripheral thread. In case of a negative result of this authorization check the central process terminates the connection to the peripheral thread. In a network system according to claim 5 it is very advantageous to prohibit any other logical connections to unit AE except the connection between AS and Z. In this case the authorization data AD is protected in the same way as the security critical data SD and can be reached only via Z and AS.

FIG. 2b shows an incarnation of a network system according to claim 5 comprising two separated networks N1 (security critical) and N2 (uncritical). Messages between N1 and N2 are not routed to prohibit any direct connections between units in N1 to units in N2. Unit ZE is connected to segment N1 via a network interface with address IP1 and to segment N2 via another network interface with address IP2. Units SE&AE in N1 are connected via the physical connection PC11/12 with network interface IP1 of unit ZE. Units PE21&PE22 in N2 are connected via the physical connection PC21/22 with network interface IP2 of unit ZE.

Unit AE stores authorization data AD and executes authorization thread AS, which maintains a standing logical connection to Z. No further connections are established, maintained or accepted by threads on AE, such that authorization data AD can only be accessed via Z and AS.

After connecting to Z P21 transmits his access data to Z (1) Z forwards the access data to AS (2), AS checks the access rights using the authorization data and sends the result to Z (3). In case of a positive (negative) result Z accepts (terminates) the connection of the peripheral thread.

For peripheral processes in uncritical segments—called uncritical clients—the open connection endpoints of the central process Z are the only targets of a potential attack. Networks according to claims 1 to 5 have the disadvantage that all uncritical clients have direct access to a central process connected to a security critical service without prior authentication and authorization (claim 1) or that the central process is loaded with the authentication and authorization (claims 4 and 5). Secondly, a denial-of-service attack of the open connection endpoints of the central process can dramatically affect the performance of the system since the central process needs to spend a large portion of its time to defend itself against unauthorized attackers.

The disadvantages of a network system according to one of the claims 1 to 5 can be eliminated by a network system according to claim 6, in which

1. a separate logon process LZ running on the same or another unit as central process Z always provides at least one open connection endpoint to which any peripheral thread can connect, and

2. the central process Z provides open connection endpoints for authorized clients only after reception of a trigger from the logon process and only for a predefined time interval.

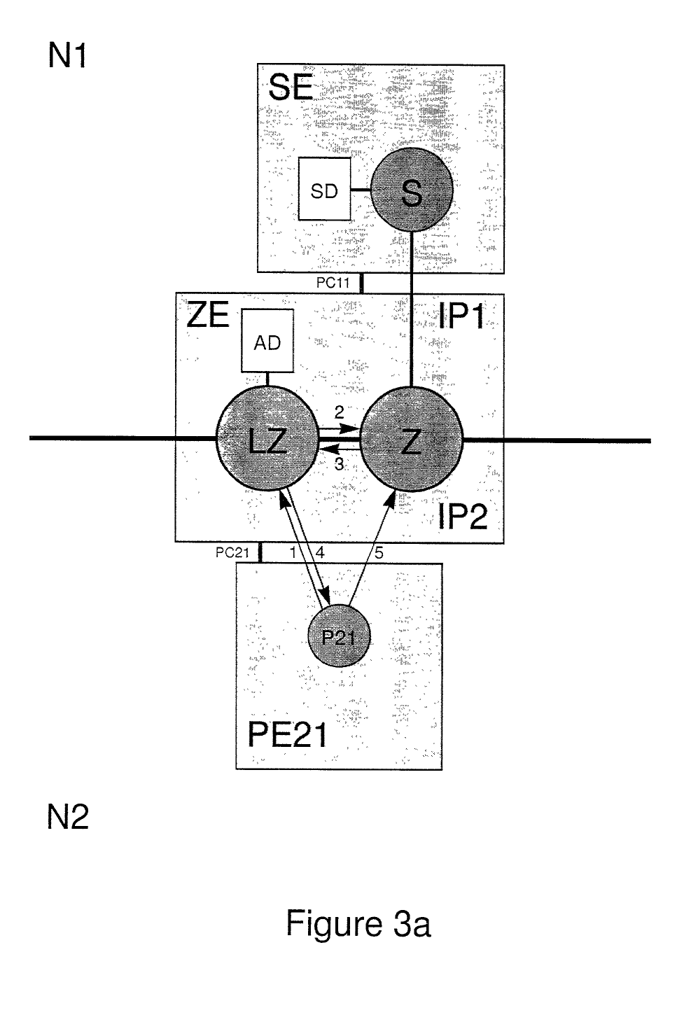

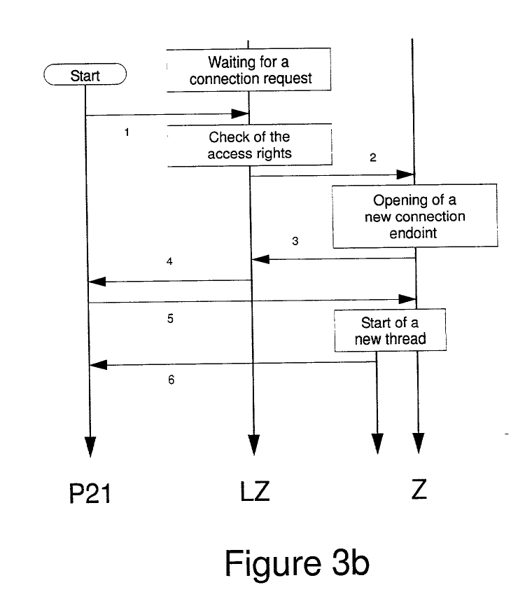

FIG. 3a) illustrates an incarnation of a network system according to claim 6 comprising two separated networks N1 (security critical) and N2 (uncritical). Messages between N1 and N2 are not routed to prohibit any direct connections between units in N1 to units in N2. Unit ZE is connected to segment N1 via a network Interface with address IP1 and to segment N2 via another network interface with address IP2. Unit SE in N1 is connected via the physical connection PC11 with network interface IP1 of unit ZE. Unit PE21 in N2 is connected via the physical connection PC21 with network interface IP2 of unit ZE.

Unit ZE executes two processes Z and LZ, which both can accept via IP1 and IP2 connections from processes running in N1 and N2. LZ always provides at least one open connection endpoint identified by a fix local identification. The local identification of the connection endpoints of LZ and the network interface address IP1 or IP2 are known by all peripheral processes in N1 or N2, such that the peripheral processes can connect anytime to LZ.

During normal operation z maintains only standing connections to LZ, S and already connected peripheral processes and does not provide any open connection endpoints. Peripheral processes from N1 or N2 cannot directly connect to Z, because Z does not provide any open connection endpoint and because the peripheral processes do not know the local identification of a potential connection endpoint of Z.

The connection build-up of a peripheral process P21 to Z follows the logical scheme illustrated in FIG. 3a) and the timeline shown in FIG. 3b). Initially P21 only knows the physical identification of network interface IP2 and the local identification of the connection endpoint of LZ. This information is enough for P21 to connect to LZ and to send its authentication information to LZ (1). LZ checks the access rights of the particular peripheral process against the authorization data AD and in case of a positive result triggers Z to provide a new connection endpoint (2). z opens a new connection endpoint and sends the local identification of the new connection endpoint back to LZ (3). LZ forwards the local identification to P21 (4). With the knowledge of the address of the network interface IP2 and the local identification P21 is able to connect to the newly opened connection endpoint of Z (5) and the connection between P21 and Z is established, if Z accepts the connection request (6). If Z denies the connection request or if P21 does not connect within a predefined time interval after Z opened the new connection endpoint, Z closes the connection endpoint and the system returns to its initial state, where no direct connections to Z can be established.

The advantage of a network system according to claim 6 is that the target of a potential attack is reduced to the absolute minimum still allowing general connectivity at any time. To bypass the loon process a potential attacker has to connect to the temporarily opened connection endpoint before the authorized peripheral process connects.

Claim 7 describes a special case of claim 6, where the connection between the logon process LZ and the central process Z is realized by a direct standing logical connection. This guarantees chat no other process can connect to the central process Z as logon process.

In a network system according to claim 8 a logon process performs additional authorization checks of peripheral processes independent of the central process and triggers the central process to open a new connection endpoint only if the peripheral process has been authenticated and authorized. This technique releases the burden of authentication and authorization tasks from the central process. Nevertheless, the authorization data AD needs to be stored on each central unit which executes a logon process. Since authorization data is itself security critical, it is advantageous to protect the authorization data according to the same principles as claims 1 to 7.

In a network system according to claim 9 the authorization data is stored on a separate unit AE in the critical segment N1. AE executes authorization service AS maintaining a standing logical connection to the logon process LZ and the central process Z. On top of the connections to LZ and Z, AS does not open or accept further connections to or from any other process. The authorization data is completely located inside the critical segment N1 and cannot be reached from uncritical segments. In addition, in a system with several logon processes AS could maintain standing connections to each of them, such that all logon processes can access the same authorization data without the need of data replication.

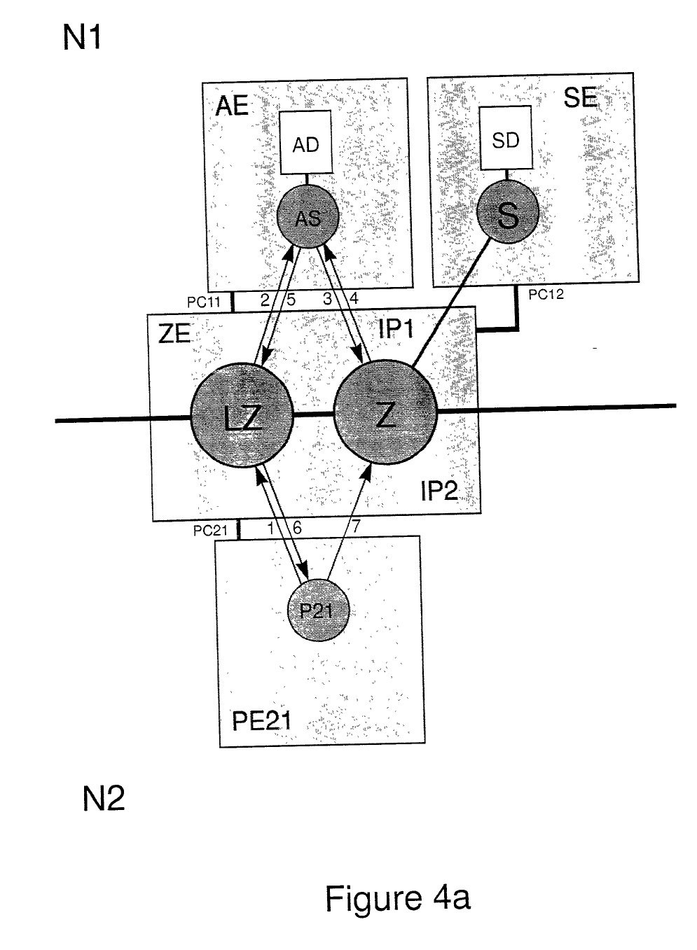

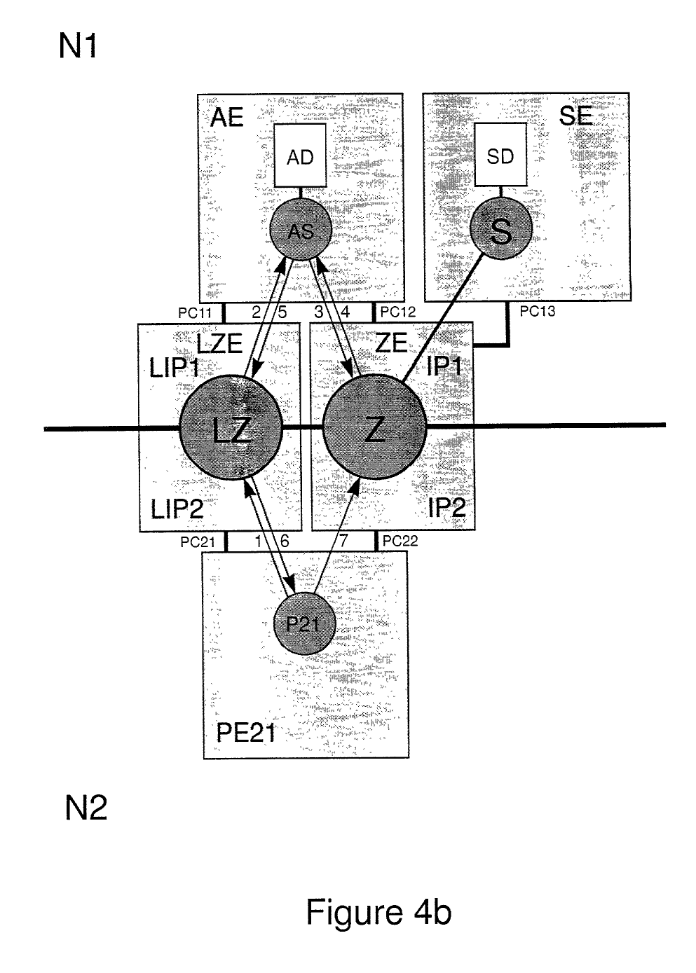

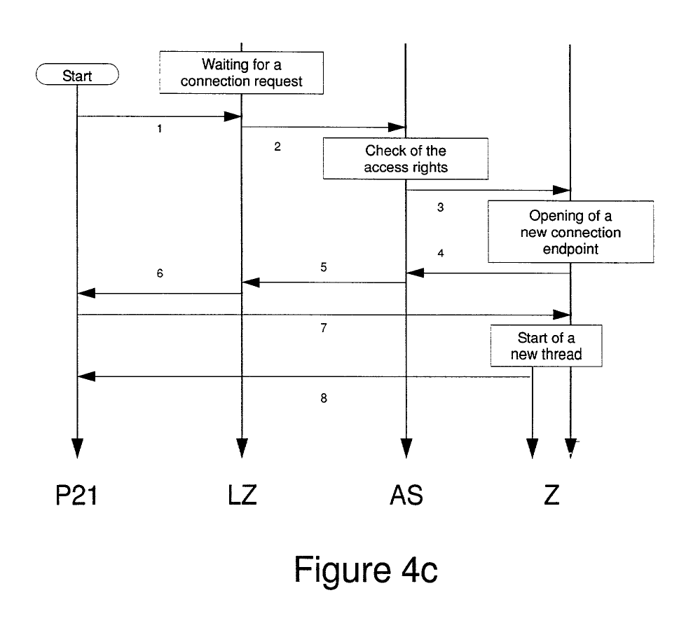

FIG. 4a) illustrates an incarnation of a network system according to claim 9 comprising two separated network segments N1 and N2. No units of segment N1 can establish direct connections to units of segment N2, because no messages are routed between N1 and N2. Unit ZE is connected to segment N1 via a network interface with address IP1 and to segment N2 via another network interface with address IP2. Units AE&SE in N1 are connected via the physical connections PCll&PC12 with network interface IP1 of unit ZE. Units PE21 in N2 is connected via the physical connection PC21 with network interface IP2 of unit ZE.

Unit ZE executes two processes Z and LZ, which can accept via IP1 resp. IP2 connections from processes running in N1 resp. N2. LZ maintains a standing connection to authorization service AS on AE and always provides at least one open connection endpoint identified by a fix local identification. The local identification of the connection endpoints of LZ and the address IP1 resp. IP2 of the network interface of ZE are known by all peripheral processes in N1 resp. N2. The peripheral processes are able to open a connection to LZ anytime.

During normal operation Z maintains only standing connections to AS, S and already connected peripheral processes and does not provide any open connection endpoints. Peripheral processes from N1 or N2 cannot directly connect to Z, because Z does not provide any open connection endpoint and because the peripheral processes do not know the local identification of a potential connection endpoint of Z.

Unit AE stores authorization data AD and executes authorization thread AS, which maintains a standing logical connections to Z and LZ. No further connections are established, maintained or accepted by threads on AE, such that authorization data AD can only be accessed via Z and AS.

The connection build-up of a peripheral process P21 to Z follows the logical scheme illustrated in FIG. 4a) and the timeline shown in FIG. 4c). Initially P21 only knows the physical identification of network interface IP2 and the local identification of the open connection endpoint of LZ. This information is enough for P21 to connect to LZ and to send its authentication date to LZ (1). LZ forwards the authentication data to AS (2), AS checks the access rights of the particular peripheral process against the authorization data AD and, in case of a positive result, triggers Z to provide a new connection endpoint (3). Z opens a new connection endpoint and sends the local identification of the new connection endpoint back to AS (4). AS forwards the local identification via LZ to P21 (5&6). With the knowledge of the address of the network interface IP2 and the local identification P21 is able to connect to the newly opened connection endpoint of Z (7) and the connection between P21 and Z is established, if Z accepts the connection request (8). If Z denies the connection request or if P21 does not connect within a predefined time interval after Z opened the new connection endpoint, Z closes the connection endpoint and the system returns to its initial state, where no direct connections to Z can be established.

FIG. 4b shows the same logical network system as FIG. 4a with the exception that the logon process LZ and central process Z are running on two different units LZE and ZE, which both are connected via network interfaces LIP1 resp. LIP2 and IP1 resp. IP2 with segments N1 resp. N2.

In this case a peripheral process from N1 resp. N2 only needs the knowledge of the physical address of network interface LIP1 resp. LIP2 and the local identification of the open connection endpoint of LZ to build up a connection to Z. The physical address IP2 of the network interface of central unit ZE executing Z, which temporarily opens a new connection endpoint, will be transmitted together with the local identification of the new connection endpoint to the authenticated peripheral process. Knowing IP2 and the local identification of the new connection endpoint provided by Z the authenticated peripheral processes is able to build-up a logical connection to Z.

Since LZ and Z are running on different units the communication between LZ and Z needs to be physically transmitted between the corresponding units. This can be accomplished by a separate direct physical connection between units LZE and ZE or via segments N1 or N2.

It is important that the communication between LZ and Z is not routed via the uncritical segment N2 (i.e. network interfaces LIP2 and IP2), otherwise the communication between LZ and Z could be “sniffed” in N2.

In networks according to claims 6 to 9 the peripheral processes/threads know the physical address of at least one network interface of at least one central process providing an open connection endpoint as well as the local identification of said connection endpoint. The physical address, e.g. the central unit itself, as well as the local identification of the connection endpoint can be static or chosen dynamically by the system. The dynamic choice of the central process or the dynamic generation of the local identification of the temporarily opened connection endpoints has the advantage that potential attackers do not know the connection parameters in advance and have to determine them in real-time for example by “port scanning”. Since a “port scan” takes some time, the time interval during which the central process opens a new connection endpoint can be chosen short enough, so that the central process will close unused open connection endpoints in most cases before their detection by an attacker. Authorized peripheral threads with the knowledge of the correct connection parameters normally connect without time delay.

It is advantageous, if the physical address of the central unit of a central process providing an open connection endpoint or the local identification of the connection endpoint are not known to a peripheral thread prior to its authentication by the logon process (claims 10 and 16). After a positive authentication one of the parameters can be dynamically chosen by either the logon process (claims 11 and 17), the central process providing the newly opened connection endpoint (claims 12 and 18) or the authorization service (claims 13 and 19), and transmitted via the logon process to the peripheral process during connection build-up.

Of particular advantage is the random or pseudo-random choice of the central unit (claim 20) or the random or pseudo-random generation of the local identification of the new connection endpoint (claim 14) to avoid that potential attackers can guess or calculate the parameters of an opened connection endpoint. An additional encryption of the connection parameters during transmission to the peripheral thread also prohibits “sniffing” (claims 15 and 21).

In addition to the dynamic generation of the local identification of a new connection endpoint and the dynamic choice of the central process, it is of further advantage to generate and to transmit to the peripheral thread further dynamical access parameters—like random one time keys—by the logon process, the authorization service or the central process. These further access parameters have to be presented by the peripheral thread as proof of authentication during connection build-up to the central process. With these access parameters the central process can verify that the correctly authenticated client tries to connect. The additional access parameters are advantageously encrypted during the transmission via the physical network.

All network systems according to claims 1 to 21 have the disadvantage, that the security critical service S provides on all its connections the same protocol. If the protocol comprises only client functionality, the remote administration of the machine or the security critical data is impossible (even for system administrators). If the protocol comprises also administrative functions, all peripheral processes gain the possibility to access those functions. This problem can partially be solved by additional authorization of administrative requests by the central process Z or the service S. Much better is of cause not to provide the possibility to access administrative functions to normal peripheral processes at all.

In a network system according to claim 22 the security critical service S is able to maintain two parallel standing connections, one to the central process Z providing normal client functionality and the other to an administrative central process—reachable only within the critical network segment providing administrative functionality.

The following claims characterize services, which allow during normal operation to switch on and off individual protocols (claims 23 to 25) as well as individual functions of individual protocols (claims 26 to 28), to load or release individual protocols (claims 29 to 31) as well as individual functions of individual protocols (claims 32 to 34).

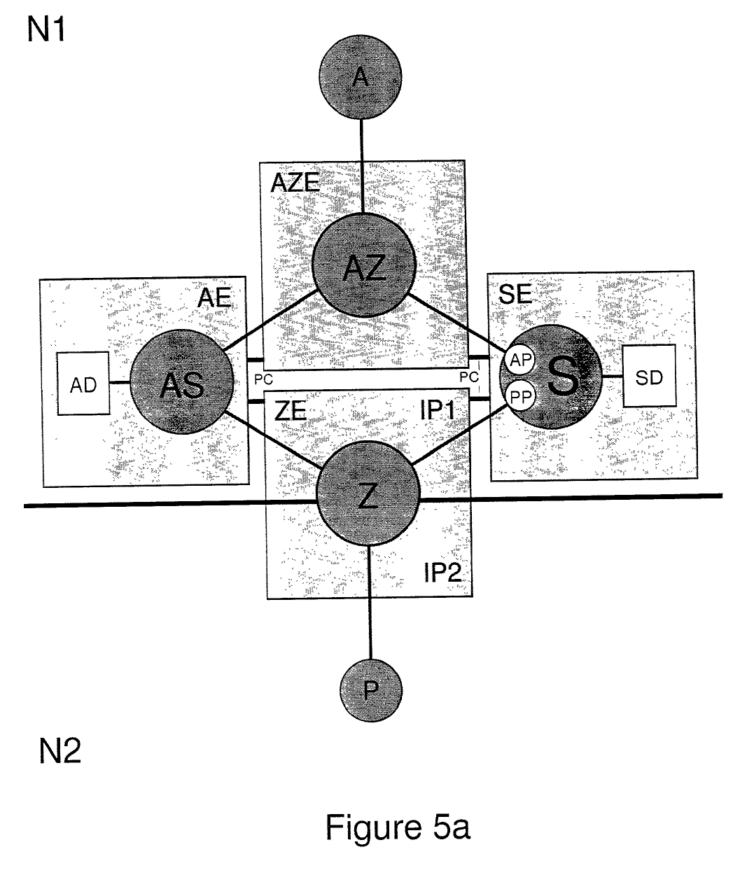

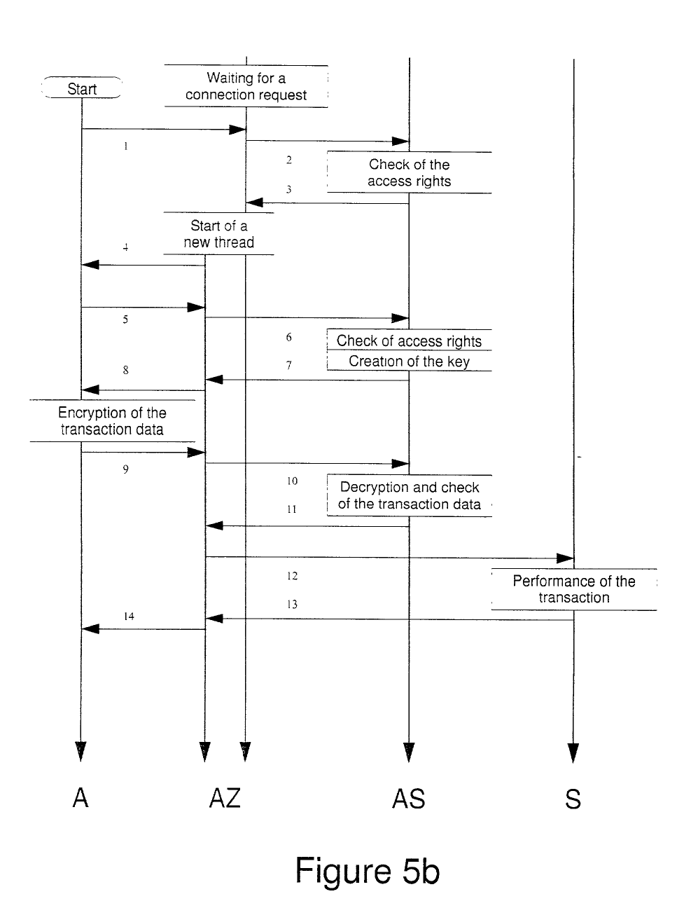

FIG. 5a shows an incarnation of a network system according to claim 22 comprising two separated network segments N1 and N2. No units of segment N1 can establish direct connections to units of segment N2, because no messages are routed between N1 and N2. Unit ZE is connected to segment N1 via a network interface with address IP1 and to segment N2 via another network interface with address IP2. Units AE&SE in N1 are connected via the physical connections PC with network interface IP1 of unit ZE and AZE.

Unit ZE executes thread Z, which can accept via IP1 resp. IP2 connections of threads running in N1 resp. N2. Z is connected via individual logical connections to authorization service AS on AE and to critical service S on SE and provides always at least one open connection endpoint with a fix local identification. The local identification of the connection endpoints of Z and the address IP1 resp. IP2 of the network interfaces of ZE are known by all peripheral processes in N1 resp. N2. All peripheral processes are able to connect to Z at any time.

Unit AZE executes thread AZ, which can accept connections of threads running in N1. AZ is connected via individual logical connections to authorization service AS on AE and to critical service S on SE and provides always at least one open connection endpoint with a fix local identification. The local identification of the connection endpoints of AZ and the physical address of AZE are known by administrative process A in N1. All administrative processes are able to connect to AZ at any time.

Unit AE stores security critical authorization data AD and executes authorization service AS, which maintains individual logical connections to AZ and Z. Those two connections are the only connections to or from threads on unit AE.

Unit SE stores security critical data SD and executes security critical service S, which maintains individual logical connections to AZ and Z. Those two connections are the only connections to or from threads on unit AF On the connection to Z S provides the peripheral protocol PP, which allows peripheral process P to access security critical data via Z and S. The peripheral protocol PP controls which functions are available for peripheral process P. In addition, transactions of peripheral Processes with S can be authorized by Z and AS.

On the connection to AZ S provides administrative protocol AP, which enables A to administer and maintain data SD via AZ. In addition, transactions of administrative processes with S can be authorized by AZ and AS.

The access of administrative functions provided by the administrative protocol AP is only granted to peripheral processes of AZ, which have to run within N1, since units in N2 have no access to AZE. In addition, Z and AZ are not connected via any logical connection. Thus peripheral processes running in N2 cannot contact AZ neither directly nor indirectly and never get access to functions of the administrative protocol AP of S.

FIG. 5b illustrates the timing of an authorized administrative transaction of A to S in the system shown in FIG. 5a. Messages 1-4 comprise the connection build-up of A to AZ authorized by AS (2&3)

At the begin of an administrative transaction A sends via AZ a request together with its identity to AS to provide a key to encrypt its authentication data (5&6). AS checks the identity of the requester, creates and stores a new random one-time key and transmits this key via AZ to A (7&8). A encrypts its authentication data with the received one-time key and sends the transaction request together with its identity, the transaction parameters and the encrypted authentication data to AZ (9). AZ forwards the identity, the encrypted authentication data and the logical quality of the transaction to AS (10). AS decrypts the authentication data with the stored one-time key and checks the correctness of the authentication data and the authorization of the transaction for A. Upon a positive result AS sends an authorization acknowledgement to AZ (11) and AZ forwards the transaction request to S (12). S executes the transaction and replies with the result via AZ to A (13&14).

Many internet service provider today have the problem, that a single (IP-address, local port) addresses only a unique server process, which easily can be overloaded with a huge number of parallel clients. It would be better if the client load would be distributed onto multiple redundant server processes running on different units. Prior art networks do not allow the addressing via a single IP-address and a single local port, because each redundant server process has its own local port address and/or each unit executing a redundant server process its own physical address. In addition, prior art client processes are able to connect to uniquely addressed server processes only.

The facts, that each peripheral thread of a network system according to claims 10 or 16 at the beginning do not know the local identification of the central process (claim 10) or do not know the physical address of the network interface of the central unit (claim 16) and that said peripheral thread receives the local identification of the central process (claim 10) or the physical address of the network interface of the central unit (claim 16) during the logon process, can be used advantageously to distribute peripheral threads onto individual subcentral processes.

In a network system according to claims 35 or 36 a peripheral thread first connects to the logon central process and receives the coordinates of a central process dynamically during the logon process. In network systems according to claims 10 or 16 the choice of the central process can be determined by any criteria. Claims 35 and 36 specify special criteria for individual applications.

If the choice of the central process depends on the authorization of the peripheral process, individual central processes can be dedicated for unauthorized guests, authenticated users and system administrators. During the logon process the peripheral threads only receive information about the authorized subsystem, such that a guest user only sees the coordinates of a guest central process and absolutely no information about other central processes accessible by authorized users or system administrators. Each central process provides only information or services corresponding to the authorization of the respective clients. This technique effectively guarantees, that individual services are addressable only by peripheral threads with the required authorization and that peripheral threads neither see the existence of services nor are able to address services without the required authorization.

For the distribution of a large number of peripheral threads onto multiple equivalent central processes—“load balancing”—the logon system chooses the destination central process according to the number of peripheral threads already connected to eligible central processes or according to the load of elgible central processes or central units. Since the load of central process or unit is subject to huge temporal variations, it is advantageous to average the process or system load over a defined time interval and to use the gliding average of the process or system load as selection criterion. The load of a central unit can be measured according to different criteria, like the number and activity of processes, the CPU load, the memory usage (core memory, secondary and/or external media).

If the choice of the central process is determined by individual features or resources required by the peripheral threads itself or by the logon system for individual peripheral threads it is possible to select only such central processes which are able to provide said required features or resources.

In such a system a peripheral thread can demand for example a connection to a central processes providing required information, services or system resources. In another example the logon system knows already that a particular type of peripheral threads requires certain information, services or system resources and chooses only such central processes able to provide the required information, services or system resources.

To optimize the system performance the choice of the central process in dependence of the geographical, network resp. system topological locations of the communication partners or the quality and speed of the connection is very important. Different connections for example are limited by their physical transmission technology to different maximum transmission rates. The maximum transmission rate determined the minimal transmission time for individual messages and therefore the overall system timing. If a single system uses different transmission techniques it is very advantageous to adapt individual subsystems to the particular transmission technique of the subsystem. This enables the logon system to select only such central processes optimized for the transmission technology used on the connection to a particular peripheral thread. A typical application is the system access via local area network (LAN) with transmission rates above 10 MBit/s on the one hand and on the other via modem and wide area network (WAN) with transmission rates in the order of 64 kBit/s. In such an environment it is very advantageous to dedicate individual subsystems with their own central process for each access mode and to select the central process according to the transmission rate to a particular peripheral thread.

In general, the maximum transmission rate of a connection between two communication partners depends not only on the physical transmission technique alone. In addition, the maximum transmission rate is limited by the geographical locations, the network topological locations—i.e. the number of physical retransmissions (by routers, switches, proxies or firewalls etc.)—and the system topological locations—i.e. the number of processes via which a message has to be transmitted—of the communication partners. In many cases it is therefore advantageous to select the central processes according to the physical transmission techniques and the said geographical, network and system topological criteria.

1. Network system comprising at least one central unit ZE, at least one service unit SE physically connected with ZE and an arbitrary number of physically with ZE connected peripheral units PE1 . . . n, wherein ZE executes at least one thread—called central process or thread—, SE executes at least one thread S called critical service—, the peripheral or central units execute an arbitrary number of peripheral threads and wherein at least one critical service can build-up or accept at least one standing logical bidirectional communication connection to or from at least one central process, and wherein on top of said connection(s) between the critical service(s) and the central process(es) no further connections can be build-up or accepted by threads running on SE, and wherein direct logical communication connections between peripheral threads running on a peripheral or a central unit and ZE can be established, such that data stored on SE is accessible for the central processes only via a critical service and for the peripheral processes only via a central process and a critical service.

2. Network system according to claim 1 wherein at least one central process assigns at least one logical identification to at least one connection to a critical service connected to said central process, such that a peripheral thread is able only with the knowledge of said logical identification(s) to communicate indirectly via said central process with at least one member out of a group of critical services, which group is uniquely identified by said logical identification(s).

3. Network system according to one of the claims 1 or 2 comprising at least two segments N1 and N2, at least one central unit ZE physically connected with each of the segments N1 and N2, at least one service unit SE in segment N1 and physically connected with ZE and an arbitrary number of peripheral units PE1 . . . n physically connected with ZE wherein direct logical communication connections between peripheral threads running on a peripheral unit within N1 or N2 or a central unit and ZE can be established, whereby said central unit(s) are able to build-up or accept direct logical connections to or from units in N1 or N2, and whereby units in N1 cannot establish direct logical connections to units in N2 with the exception of said central process(es), and whereby units in N2 cannot establish direct logical connections to units in N1 with the exception of said central process (es), and whereby units in N1 cannot accept direct logical connections from units in N2 with the exception of said central process(es), and whereby units in N2 cannot accept direct logical connections from units in N1 with the exception of said central process(es).

4. Network system according to one of claims 1 to 3, wherein the central unit ZE stores authorization data AD and wherein at least one peripheral thread after connecting to the central process Z on ZE transmits access data to Z, and wherein Z checks the access rights of the peripheral process by checking said access data against said authentization data AD, and wherein Z terminates the connection to said peripheral process if the result of said check of said access rights is negative.

5. Network system according to one of claims 1 to 3, wherein at least one Unit AE directly or indirectly physically connected with central unit ZE stores authorization data AD and wherein AE executes at least one authorization thread AS able to build-up or accept a standing logical connection to or from Z, and wherein at least one peripheral thread after build-up of the connection to central process Z sends Z access data, and wherein Z receives said access data and forwards said access data to AS, and wherein AS receives said access data, checks the access rights of said peripheral process by checking said access data against said authorization data AD and transmits the result of said check of said access rights to Z, and wherein Z terminates the connection to said peripheral process if the result of said check of said access rights is negative.

6. Network system according to claim 1, wherein at least one central unit executes at least one thread—called logon process or thread—providing at all times at least one open connection endpoint identified by a fix local identification, and wherein no central process(es) provide open connection endpoints without prior trigger from said logon process, and wherein at least one peripheral thread to connect to a central process(es) establishes first a connection to said logon process, and wherein said logon process via an arbitrary interthread- or interprocess communication medium triggers at least one central process to open a new connection endpoint, and wherein at least one of the triggered central processes opens for a predefined time interval a new connection endpoint with a local identification known to said peripheral thread, and wherein said peripheral thread connects to at least one of said opened connection endpoint(s) of at least one central process within said predefined time interval, and wherein all triggered central processes close all opened connection endpoints to which said peripheral process did not connect to within said predefined time interval.

7. Network system according to claim 6 wherein the communication medium between at least one logon process and at least one central process is a standing logical connection.

8. Network system according to one of the claims 6 or 7 wherein at least one peripheral thread transmits to the logon process additional access data, and wherein the logon process checks the access rights of said peripheral process by checking said access data against predefined authorization data, and wherein said logon process triggers at least one central process to open a new connection endpoint only if said authorization check returns a positive result.

9. Network system according to claim 6 wherein at least one unit AE stores authorization data, and wherein each of the unit(s) AE is(are) physically connected to at least one central unit, and wherein each of the unit(s) AE executes an authorization service AS, which service is able to establish or to accept standing logical connections to or from at least one logon process and to or from at least one central process, and wherein a peripheral thread after connecting to a logon process sends said logon process its access data, and wherein said logon process forwards each connection request of a peripheral thread together with said access data to said authorization service AS, and wherein said authorization service AS checks the access rights of said peripheral thread by checking said access data against authorization data AD and in case of a positive result triggers at least one central process to open a new connection endpoint, and wherein at least one of the triggered central processes provides for a predefined time interval a new open connection endpoint with a local identification known to said peripheral thread, and wherein said peripheral thread connects to at least one of said temporarily opened connection endpoint(s) within said predefined time interval, and wherein all central process(es) close all temporarily opened connection endpoints to which said peripheral thread did not connect to within said predefined time interval.

10. Network system according to one of the claims 6 to 9 wherein at least one peripheral thread does not know the local identification of at least one temporarily opened connection endpoint by at least one central process, and wherein said peripheral thread receives said local identification from at least one logon process.

11. Network system according to claim 10 wherein at least one logon process generates at least one local identification of at least one connection endpoint to be provided by at least one of the central processes and transmits said generated local identification during connection build-up to at least one peripheral thread and to at least one central process providing a new temporarily opened connection endpoint with said local identification.

12. Network system according to claim 10 wherein at least one central process generates at least one local identification of at least one connection endpoint to be provided by at least one of the central processes and transmits said generated local identification during connection build-up via at least one logon process to at least one peripheral thread.

13. Network system according to claims 9 and 10 wherein at least one authorization service generates at least one local identification of at least one connection endpoint to be provided by at least one of the central processes and transmits said generated local identification during connection build-up via at least one logon process to at least one peripheral thread and to at least one central process providing at least one temporarily open connection endpoint with said generated local identification.

14. Network system according to one of claims 9 to 13 wherein at least one local identification of at least one temporarily opened connection endpoint of at least one central process is generated randomly or pseudo-randomly.

15. Network system according to one of claims 9 to 14 wherein at least one local identification of at least one temporarily opened connection endpoint of at least one central process is transmitted in at least one encrypted message.

16. Network system according to one of the claims 6 to 15 wherein at least one peripheral thread does not know the physical address of the network interface of at least one target central unit, and wherein said peripheral thread receives from at least one logon process the physical address of at least one network interface of at least one central unit executing at least one central process providing at least one temporarily open connection endpoint.

17. Network system according to claim 16 wherein at least one logon process selects at least one central process Z1 providing at least one temporarily open connection endpoint and transmits the physical address of the network interface of the central unit executing Z1 to at least one peripheral thread during connection build-up.

18. Network system according to claim 16 wherein at least one central process selects at least one central process Z1 providing at least one temporarily open connection endpoint and transmits via at least one logon process the physical address of the network interface of the central unit executing Z1 to at least one peripheral thread during connection build-up.

19. Network system according to one of the claims 9 to 16 wherein at least one authorization service selects at least one central process Z1 providing at least one temporarily open connection endpoint and transmits via at least one logon process the physical address of the network interface of the central unit executing Z1 to at least one peripheral thread during connection build-up.

20. Network system according to one of the claims 16 to 19 wherein at least one central process is selected randomly or pseudo-randomly.

21. Network system according to one of the claims 16 to 20 wherein the physical address of at least one network interface of at least one central unit running at least one central process providing at least one temporarily open connection endpoint is transmitted in encrypted form.

22. Network system according to one of the previous claims wherein at least one service builds-up or accepts at least one standing logical connection to or from at least two central processes, and wherein said service provides on at least two of its connections different protocols.

23. Network system according to one of the previous claims wherein at least one of the protocols of at least one service can be activated during operation.

24. Network system according to one of the previous claims wherein at least one of the protocols of at least one service can be deactivated during operation.

25. Network system according to one of the claims 23 or 24 wherein the activation or deactivation of at least one protocol of at least one service is controlled by at least one function of at least one protocol of said service.

26. Network system according to one of the previous claims wherein at least one function of at least one protocol of at least one service can be activated during operation.

27. Network system according to one of the previous claims wherein at least one function of at least one protocol of at least one service can be deactivated during operation.

28. Network system according to one of the claims 26 or 27 wherein the activation or deactivation of at least one function of at least one protocol of at least one service is controlled by at least one function of at least one protocol of said service.

29. Network system according to one of the previous claims wherein at least one protocol of at least one service can be loaded into the addressable memory space of said service during operation.

30. Network system according to one of the previous claims wherein at least one protocol of at least one service can be removed from the addressable memory space of said service during operation, such that all functions of said removed protocol can only be called again after said protocol has been loaded again into the addressable memory space of said service.

31. Network system according to one of the claims 29 or 30 wherein the loading or removal of at least one protocol of at least one service is controlled by at least one function of at least one protocol of said service.

32. Network system according to one of the previous claims wherein at least one function of at least one protocol of at least one service can be loaded into the addressable memory space of said service during operation.

33. Network system according to one of the previous claims wherein at least one function of at least one protocol of at least one service can be removed from the addressable memory space of said service during operation, such that said removed function can only be called again after said removed function has been loaded again into the addressable memory space of said service.

34. Network system according to one of the claims 32 or 33 wherein the loading or removal of at least one function of at least one protocol of at least one service is controlled by at least one function of at least one protocol of said service.

35. Network system according to claim 10 wherein the choice of a central process depends on the authorization of said peripheral thread, or the number of peripheral threads connected to each eligible central process, or on the load of each eligible central process, or on the system demands of said peripheral thread, or on the quality and speed of the connection between said peripheral thread and the logon central process or each eligible central process, or on the geographical position(s) of the eligible central unit(s) or the peripheral unit executinq said peripheral thread, or on the network topological location(s) of the peripheral and eligible central unit(s), or on the system topological location(s) of the peripheral thread or the eligible central process(es).

36. Network system according to claim 16 wherein the choice of a central unit executing an eligible central process—called eligible unit—depends on the authorization of said peripheral thread, or the number of peripheral threads connected to each eligible central process or central unit, or on the load of each eligible central unit, or on the system demands of said peripheral thread, or on the quality and speed of the connection between each eligible central process and said peripheral thread, or on the geographical position(s) of the eligible central unit(s) or the peripheral unit executing said peripheral thread, or on the network topological location(s) of the peripheral and eligible central unit(s), or on the system topological location(s) of the peripheral thread or the eligible central unit(s) running eligible central process(es).
